(19) United States
(12) Patent Application Publication
(10) Pub. No.: US 2026/0288907 A1
(43) Pub. Date: Sep. 24, 2026

(54) MULTIMODAL SEARCH SYSTEM

(71) Applicant: THUMBTACK, INC., San Francisco, CA (US)

(72) Inventors: Marios Kokkodis, Long Island City, NY (US); Erin Hogan, Brooklyn, NY (US); Katherine Zhu, Brooklyn, NY (US)

(21) Appl. No.: 19/571,154

(22) Filed: Mar. 18, 2026

Related U.S. Application Data
(60) Provisional application No. 63/774,600, filed on Mar. 19, 2025.

(51) Int. Cl. G06F 18/241

(52) U.S. Cl. CPC G06F 18/241

(57) ABSTRACT

Systems and methods for multimodal search and category classification are disclosed. A method can include receiving user input data indicative of a user input received by a user device where the user input includes a text input and a media input, generating, by a multimodal embeddings model, respective vector embeddings representing the user input data, aggregating the generated vector embeddings into a combined vector representation, applying a trained multiclass classification model to the aggregated vector representation to generate a probability distribution over a predefined plurality of categories, selecting a predicted category from the plurality of categories based on the probability distribution, and providing display data to the user device based on the selected predicted category where the display data is configured to cause the user device to display a user interface based on the selected predicted category.

### CROSS-REFERENCE TO RELATED APPLICATIONS

This application claims the benefit of and priority to U.S. Provisional Patent Application No. 63/774,600, filed Mar. 19, 2025, the entire disclosure of which is incorporated herein by reference in its entirety and for all purposes.

### BACKGROUND

Service matching platforms can connect users with service professionals for a variety of tasks, such as home repair, landscaping, or other specialized services. Users typically describe their service needs using keyword-based search interfaces or structured forms that guide them through predefined categories. However, enabling users to express their service needs using natural language descriptions and media, such as images, in a flexible, unstructured manner presents technical challenges in accurately classifying user intent and matching it to appropriate service categories.

### SUMMARY

At least one embodiment relates to a method. The method can include receiving, from a user device, user input data indicative of a user input received by the user device, the user input comprising a text input and a media input. The method can include generating, by a multimodal embeddings model, respective vector embeddings representing the user input data. The method can include aggregating the generated vector embeddings into a combined vector representation. The method can include applying a trained multiclass classification model to the aggregated vector representation to generate a probability distribution over a predefined plurality of categories. The method can include selecting a predicted category from the plurality of categories based on the probability distribution. The method can include providing, to the user device, display data based on the selected predicted category, the display data configured to cause the user device to display a user interface based on the selected predicted category.

At least one embodiment relates to a system. The system can include one or more processors coupled to one or more non-transitory computer-readable storage mediums comprising program instructions that, when executed by the one or more processors, cause the one or more processors to perform operations. The system can receive, from a user device, user input data indicative of a user input received by the user device, the user input comprising a text input and a media input. The system can generate, by a multimodal embeddings model, respective vector embeddings representing the user input data. The system can aggregate the generated vector embeddings into a combined vector representation. The system can apply a trained multiclass classification model to the aggregated vector representation to generate a probability distribution over a predefined plurality of categories. The system can select a predicted category from the plurality of categories based on the probability distribution. The system can provide, to the user device, display data based on the selected predicted category, the display data configured to cause the user device to display a user interface based on the selected predicted category.

At least one embodiment relates to a non-transitory computer storage medium encoded with a computer program. The computer program can include a plurality of program instructions that when executed by one or more processors cause the one or more processors to perform operations. The operations can include receiving, from a user device, user input data indicative of a user input received by the user device, the user input comprising a text input and a media input. The operations can include generating, by a multimodal embeddings model, respective vector embeddings representing the user input data. The operations can include aggregating the generated vector embeddings into a combined vector representation. The operations can include applying a trained multiclass classification model to the aggregated vector representation to generate a probability distribution over a predefined plurality of categories. The operations can include selecting a predicted category from the plurality of categories based on the probability distribution. The operations can include matching a user associated with the user device with a service professional based on the selected predicted category corresponding to a service offered by the service professional.

These and other aspects are discussed in detail below. The foregoing information and the following detailed description include illustrative examples of various aspects and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram illustrating a multimodal search system, according to an example embodiment;

FIG. 2 is a block diagram illustrating the memory of FIG. 1 in greater detail, according to an example embodiment;

FIG. 3 is a flowchart illustrating an embeddings-based category prediction method for generating an output responsive to a user-provided input, according to an example embodiment;

FIG. 4 is a flow diagram illustrating another embeddings-based category prediction method for generating an output responsive to a user-provided input, according to an example embodiment;

FIG. 5 is an illustration of a user interface for entering a service request query and initiating a search within the multimodal search system, according to an example embodiment;

FIG. 6 is a user interface view of a multimodal search input screen for submitting a query using multiple input modalities, according to an example embodiment;

FIG. 7 is an illustration of a user interface of a multimodal search interface showing receipt of a media input, according to an example embodiment;

FIG. 8 is an illustration of a user interface of a multimodal search input screen showing receipt of a media input and input text, according to an example embodiment; and

FIG. 9 is an illustration of a user interface of a multimodal search output screen presenting a predicted category, according to an example embodiment.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

This disclosure relates to techniques for classifying multimodal user inputs into predefined service categories using embeddings-based models and trained classification models. Service matching platforms can connect users with service professionals for a variety of tasks, such as home repair, landscaping, or other specialized services. Users typically describe the service needs using keyword-based search interfaces or structured forms that guide the users through predefined categories. To facilitate matching, conventional systems can rely on users manually selecting from a taxonomy of categories or entering structured information that maps to a particular category. For example, a user seeking a home repair service may navigate through hierarchical menus of service categories or may enter specific keywords that correspond to predefined categories maintained by the platform.

Conventional systems that rely on keyword-based search interfaces or structured category selection can limit the flexibility with which users can express the service needs, particularly when a user cannot easily identify the appropriate category from a list or when the user prefers to describe a problem using natural language and visual information. Requiring users to manually select from a taxonomy of categories can result in mismatches between user intent and the selected category, such that the matching with service professionals can be inefficient. Conventional systems may not support multimodal inputs, such as combinations of text descriptions and images, which can provide richer context for understanding user needs. The inability to process unstructured multimodal inputs can result in lower accuracy in inferring the correct service category and can degrade the user experience by requiring additional user interactions to refine or correct category selections. Conventional approaches that rely on large language models (LLMs) to classify user inputs using prompting techniques can suffer from poor calibration of confidence scores, such that the predicted probabilities generated by such models can be concentrated in narrow ranges and can fail to provide meaningful signals for downstream decision-making. Prompting-based approaches can also exhibit high latency and cost, particularly when processing multimodal inputs that include images, such that real-time deployment of such approaches can be impractical for interactive user-facing applications.

The techniques described herein provide approaches for classifying user inputs into service categories by processing multimodal data using embeddings-based models and trained classification models. To do so, the techniques described herein can employ a multimodal embeddings model to generate numerical representations of both text and media inputs in a shared embedding space, such that the representations can be aggregated into a combined vector. A trained multiclass classification model can be applied to the aggregated vector to generate a probability distribution over a predefined set of service categories, such that a predicted category can be selected based on the probability distribution.

To implement the techniques described herein, a multimodal embeddings model can generate vector embeddings for text inputs and for media inputs received from a user device. In some implementations, the system can scale media inputs to any size range to reduce operations costs. For example, the system can scale media inputs that are images from higher pixel counts to a lower pixel count (e.g., 1000 pixel by 1000 pixel image scaled to a 250 pixel by 250 pixel image) before the multimodal embeddings model processes the images to reduce computational costs. The embeddings model can be a pre-trained transformer model that represents text and images in the same contextual space, such that the embeddings model can produce embeddings that capture semantic relationships between text and images. The generated vector embeddings can be aggregated into a combined vector representation. When multiple images are provided, the image embeddings can be averaged to produce a single image representation, and the image representation can be combined with the text representation to produce the combined vector. A trained multiclass classification model can be applied to the aggregated vector representation to generate a probability distribution over a predefined plurality of categories. The multiclass classification model can be a logistic regression model that has been trained using labeled training data derived from historical user interactions, such that the model can learn patterns specific to the service platform. The labeled training data can be constructed by associating historical user inputs with categories corresponding to professionals contacted by users, such that the ground truth labels reflect actual user choices. A predicted category can be selected from the plurality of categories based on the probability distribution. The system can select the category having the highest probability in the probability distribution or can generate a ranked list of alternative predicted categories based on the probability distribution. Display data based on the selected predicted category can be provided to the user device, such that the user device can display a user interface based on the selected predicted category. The user interface can present the predicted category to the user for confirmation or can prompt the user to provide additional information if the confidence score derived from the probability distribution is below a threshold.

The techniques described herein can enable users to express the service needs using natural language and images without requiring manual category selection, such that the system can automatically infer the appropriate service category with improved accuracy compared to keyword-based or structured input approaches. The embeddings-based approach described herein can be trained using proprietary labeled data that reflects domain-specific category definitions, such that the classification model can learn patterns specific to the service platform that may not be captured by general-purpose language models trained on public data. The techniques described herein can generate calibrated probability scores that can be used to determine confidence in predictions, such that the system can prompt users for additional information when confidence is below a threshold or can present alternative category suggestions ranked by likelihood. By using a trained classification model applied to embeddings rather than prompting-based approaches, the techniques described herein can reduce latency and cost, such that real-time processing of multimodal inputs can be achieved with minimal computational overhead. The techniques described herein can provide up to 49.5% higher accuracy than prompting-based approaches in classifying multimodal user inputs into service categories, such that the matching between users and service professionals can be more efficient and accurate, which reduces operational costs relative to LLM model techniques. The probability distributions generated by the techniques described herein can be calibrated, such that the predicted probabilities can provide meaningful confidence signals for downstream decision-making, in contrast to prompting-based approaches that can produce overly concentrated and uninformative probability scores.

As used herein, media input refers to any type of media or any type of data other than text data, including but not limited to images, videos, or audio recordings. In some cases, the specification specifically refers to image data when describing example implementations, which one of ordinary skill in the art will appreciate is solely for ease of reference and not to limit those specific implementations to only receiving image input data.

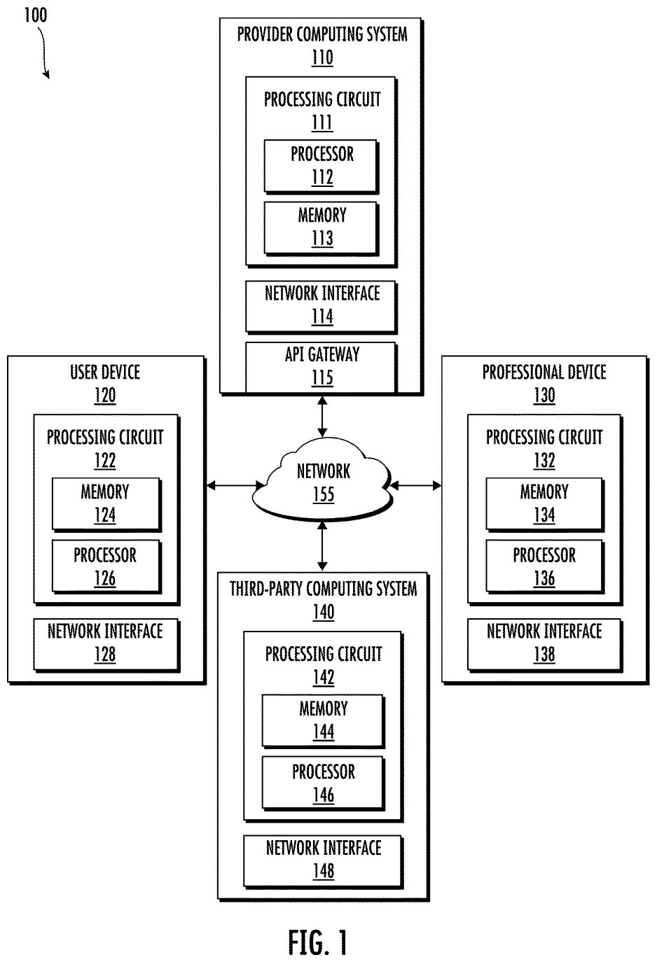

Referring now to FIG. 1, a block diagram illustrating a multimodal search system 100 is shown, according to an example embodiment. The system 100 can include a provider computing system 110, a user device 120, a professional device 130, a third-party computing system 140, and a network 155.

The system 100 can include a provider computing system 110. The provider computing system 110 can be a server system, cloud-based platform, or distributed computing infrastructure configured to process multimodal user inputs and generate category predictions by executing embeddings-based models and trained classification models. For example, the provider computing system 110 can include one or more GPU-based servers configured to execute multimodal embeddings models and trained classification models with minimal latency. The provider computing system 110 can receive user input data including natural language text and images from user devices 120 via the network 155, generate vector embeddings for the inputs using a multimodal embeddings model implemented by the embeddings system 210, aggregate the embeddings into combined vector representations using the aggregator system 220, and apply trained multiclass classification models implemented by the classification model 230 to generate probability distributions over predefined service categories. The provider computing system 110 can select predicted categories from the plurality of categories based on the probability distributions and can provide display data to user devices 120 to cause the user devices to display user interfaces presenting the predicted categories for user confirmation or refinement. In some implementations, the provider computing system 110 can determine confidence scores based on the probability distributions and can prompt user devices 120 to request additional user input when confidence scores fall below predefined thresholds, such that users can provide supplemental information to improve prediction accuracy. For example, the provider computing system 110 can determine a confidence score based on the probability distribution generated by the classification model 230, and can include a prompt for additional user input in the display data when the confidence score falls below a predefined threshold, such that the user device 120 can render a user interface prompting the user to provide additional text input or media input to improve prediction accuracy.

The provider computing system 110 can include a processing circuit 111. The processing circuit 111 can be a hardware component including one or more processors, memory, and associated control logic configured to execute instructions for multimodal input processing and category classification. In some embodiments, the processing circuit 110 can include a processor 112 and memory 113.

The processing circuit 111 can include a processor 112. The processor 112 can be a central processing unit (CPU), graphics processing unit (GPU), tensor processing unit (TPU), or other computational hardware configured to execute instructions for multimodal data processing and classification. For example, the processor 112 can include an GPU or similar hardware optimized for executing transformer-based embeddings models and neural network inference with low latency. The processor 112 can execute instructions to implement a multimodal embeddings model that generates vector embeddings for text and images, to perform aggregation operations that combine embeddings into unified representations, and to apply trained multiclass classification models to generate probability distributions over service categories. In some implementations, the processor 112 can compute confidence scores from probability distributions and can execute decision logic to determine whether to present predicted categories to users or to prompt users for additional information. For example, the processor 112 may compare a maximum probability value from the probability distribution to a predefined threshold value and may generate a prompt request when the maximum probability value falls below the threshold, such that users can provide supplemental input to improve prediction accuracy. The processor 112 may access model parameters, training data, and inference instructions from the memory 113. In some implementations, the processor 112 can execute batch processing operations to generate embeddings for multiple user inputs simultaneously, such that throughput can be increased when processing multiple concurrent user requests.

The processing circuit 111 can include a memory 113. The memory 113 can be a non-transitory computer-readable storage medium storing processor-executable instructions, model parameters, training data, and intermediate computation results. For example, the memory 113 can include random-access memory (RAM), solid-state drives, or other storage media that store weights for multimodal embeddings models, coefficients for trained models, and aggregation algorithm implementations. The memory 113 can store instructions that, when executed by the processor 112, cause the processor 112 to receive user input data, generate vector embeddings using a multimodal embeddings model, aggregate the embeddings, and apply a trained multiclass classification model to generate probability distributions. In some implementations, the memory 113 can store labeled training data generated by associating historical user inputs with categories corresponding to professionals contacted by users, such that the training data can be accessed by the processor 112 to train or update the multiclass classification model. The memory 113 may store the instructions in executable formats accessible to the processor 112, such that the processor 112 can load and execute the instructions to implement the processes and methods disclosed herein.

The provider computing system 110 can include a network interface 114. The network interface 114 can be a hardware or software component that facilitates communication between the provider computing system 110 and external devices via the network 155. For example, the network interface 114 can include network adapters, communication protocols, and data transmission logic configured to receive user input data from user devices 120 and to transmit display data to user devices 120. The network interface 114 can receive user input data including text inputs and media inputs from user devices 120, and can transmit display data configured to cause user devices 120 to display user interfaces presenting predicted categories or prompts for additional information. In some implementations, the network interface 114 can communicate with professional devices 130 to transmit matching information based on predicted categories corresponding to services offered by professionals. For example, the network interface 114 may transmit a JSON object containing a top-ranked predicted category identifier, a ranked list of up to ten category identifiers with associated probability scores reflecting likelihood, and user contact information to a professional device 130 associated with a service professional offering services in the predicted category, such that the professional can review the user service request and respond with availability or pricing information. The network interface 114 may implement communication protocols such as HTTP, HTTPS, WebSocket, or other protocols to facilitate data exchange between the provider computing system 110 and devices connected to the network 155. For example, the network interface 114 may construct HTTP POST requests containing user input data encoded as multipart form data with separate fields for text input strings and media input binary data, transmit the requests to API endpoints exposed by the API gateway 115, and receive HTTP responses containing JSON payloads with predicted category identifiers and probability distributions for rendering on user devices 120.

The provider computing system 110 can include an API gateway 115. The API gateway 115 can be a software component or hardware interface that exposes one or more application programming interfaces (APIs) configured to facilitate communication among various external devices (e.g., the user device 120, the professional device 130, the third-party computing system 140). The API gateway 115 may provide a plurality of APIs to other components of the system 100 to provide various services or functionalities of the provider computing system 110. For example, APIs may be provided to the third-party computing system 140 to run the various models and processes described herein on behalf of the provider computing system 110. Additionally or alternatively, APIs may be provided to the third-party computing system 140 (e.g., financial institutions or payment source accounts for customers) to authenticate and facilitate payments between customers and service professionals. One or more APIs may also be provided to partially or fully reverse payments or issue refunds. These APIs are included as examples, and it should be understood that the API gateway 115 may provide various additional or alternative APIs to provide various additional or alternative services.

The system 100 can include a user device 120. The user device 120 can be a computing device operated by a user seeking to describe service needs using natural language text and images. For example, the user device 120 can include a smartphone, tablet, laptop, desktop computer, or other computing device configured to display user interfaces for entering service request queries. The user device 120 can receive user inputs including text descriptions and images via user interfaces, transmit user input data to the provider computing system 110 via the network 155, and display predicted categories or prompts for additional information based on display data received from the provider computing system 110. In some implementations, the user device 120 can display user interfaces configured to simultaneously accept natural language text and media inputs, such that users can describe service needs using multiple input modalities. For example, the user device 120 may present an interface region containing a text input field, an image attachment button, and a voice input button, such that a user may provide a typed description of lawn damage, attach a photograph showing bare patches on grass, and optionally record audio to input via the user device 120, all within a single submission flow prior to initiating the search. The user device 120 may execute a client application or web browser that renders user interfaces for multimodal search, captures user inputs, and communicates with the provider computing system 110 to obtain category predictions. The user device 120 may receive display data from the provider computing system 110, and may render user interface elements based on the received display data by populating text labels, activating confirmation buttons, or displaying input prompts according to structured data fields in the display data.

The user device 120 can include a processing circuit 122, a memory 124, a processor 126, and a network interface 128. The processing circuit 122, the memory 124, the processor 126, and the network interface 128 can be similar to the processing circuit 111, the memory 113, the processor 112, and the network interface 114 of the provider computing system 110 described above with reference to FIG. 1, respectively. The processing circuit 122 can execute instructions to display user interfaces for receiving text inputs and media inputs, to capture user inputs from input devices such as keyboards, touchscreens, or cameras, and to transmit user input data to the provider computing system 110 via the network interface 128. In some implementations, the processing circuit 122 can execute instructions to receive display data from the provider computing system 110 and to render user interfaces presenting predicted categories, alternative category suggestions, or prompts for additional user input. The memory 124 can store client application instructions, user interface assets, and temporary data associated with multimodal search functionality, such that the processor 126 can access the instructions to implement user-facing components of the multimodal search system 100. The network interface 128 can transmit user input data including text inputs and media inputs to the provider computing system 110, and can receive display data configured to cause the user device 120 to display user interfaces presenting predicted categories or prompts for additional information.

The system 100 can include a professional device 130. The professional device 130 can be a computing device operated by a service professional who offers services in one or more categories defined in the predefined plurality of categories, such that the professional device 130 can receive notifications and matching information when users submit service requests corresponding to categories offered by the professional. For example, the professional device 130 can include a smartphone, tablet, laptop, or desktop computer configured to execute a client application or web browser that communicates with the provider computing system 110 to receive matching information based on predicted categories corresponding to services offered by the professional. The professional device 130 can receive matching information from the provider computing system 110 via the network 155, such that the professional can be notified of users seeking services in categories offered by the professional. In some implementations, the professional device 130 can display user interfaces presenting user service requests, predicted categories, and user contact information to facilitate service matching and communication between professionals and users. For example, the professional device 130 may render a user interface displaying a predicted category identifier such as “Lawn Care Services” alongside a user-provided text description stating “I need to fix these bare patches” and an image thumbnail showing damaged lawn areas, such that the professional can evaluate the service request and determine whether to respond with availability information or pricing quotes. The professional device 130 may receive notifications of new service requests transmitted by the provider computing system 110 when the classification model 230 selects a predicted category that matches a category offered by the service professional associated with the professional device 130, view details of predicted categories associated with user requests including confidence scores derived from the probability distributions generated by the classification model 230, and transmit responses or quotes to users via the provider computing system 110 by generating response messages containing availability information, pricing estimates, or service capability descriptions.

The professional device 130 can include a processing circuit 132, a memory 134, a processor 136, and a network interface 138. The processing circuit 132, the memory 134, the processor 136, and the network interface 138 can be similar to the processing circuit 111, the memory 113, the processor 112, and the network interface 114 of the provider computing system 110 described above with reference to FIG. 1, respectively. The processing circuit 132 can execute instructions to receive matching information from the provider computing system 110, to display user interfaces presenting user service requests and predicted categories, to capture professional inputs confirming availability to provide services in predicted categories, and to transmit professional responses or quotes to the provider computing system 110. In some implementations, the processing circuit 132 can execute instructions to capture professional inputs and to transmit confirmation data to the provider computing system 110 via the network interface 138, such that the confirmation data can be forwarded to users seeking services. The memory 134 can store client application instructions, user interface assets, received matching information, and temporary data associated with service matching functionality, such that the processor 136 can access the instructions to render user interfaces presenting details of user service requests, predicted categories, and user contact information. The network interface 138 can receive matching information from the provider computing system 110, and can transmit professional responses or quotes to the provider computing system 110 to facilitate communication between professionals and users.

The system 100 can include a third-party computing system 140. The third-party computing system 140 can be an external computing system that provides services, data, or functionality integrated with the multimodal search system 100. For example, the third-party computing system 140 can include external embeddings model providers that host pre-trained multimodal transformer models, authentication services that verify user credentials or application programming interface (API) tokens, payment processing systems that facilitate financial transactions between users and service professionals, or data enrichment services that augment user input data with additional contextual information such as geographic metadata or service availability data. The third-party computing system 140 can communicate with the provider computing system 110 via the network 155 to provide external services such as embeddings model inference operations, user authentication operations, or data validation operations. In some implementations, the third-party computing system 140 can provide pre-trained embeddings models or model weights that can be accessed by the provider computing system 110 to generate vector embeddings for user inputs. For example, the third-party computing system 140 may host a pre-trained OpenCLIP model with weights corresponding to a vision transformer architecture, and may expose an API endpoint that accepts text inputs or media inputs and returns corresponding vector embeddings in a shared contextual embedding space, such that the provider computing system 110 can invoke the API endpoint to generate embeddings without maintaining local copies of the model weights. The third-party computing system 140 may execute operations by loading processor-executable instructions from the memory 144 into the processor 146, such that the processor 146 can perform external service operations requested by the provider computing system 110. The operations may include processing API requests from the provider computing system 110 by parsing request payloads to extract text inputs or media input, executing external models or services by performing forward passes through transformer layers or by invoking authentication protocols, and returning results or data to the provider computing system 110 via the network 155 by constructing response payloads containing vector embeddings, authentication tokens, or validation results. In some embodiments, the processing circuit 111 or the components of processing circuit 111 are located on the third-party computing system 140, or the third-party computing system 140 is configured to perform some of or all of the same functions as the processing circuit 111.

The third-party computing system 140 can include a processing circuit 142, a memory 144, a processor 146, and a network interface 148. The processing circuit 142, the memory 144, the processor 146, and the network interface 148 can be similar to the processing circuit 111, the memory 113, the processor 112, and the network interface 114 of the provider computing system 110 described above with reference to FIG. 1, respectively. The processing circuit 142 can execute instructions to process API requests from the provider computing system 110, to perform external service operations such as embeddings model inference or data validation, and to return results or data to the provider computing system 110. In some implementations, APIs may be provided to the third-party computing system 140 (e.g., financial institutions or payment source accounts for customers) to authenticate and facilitate payments between customers and service professionals, or to partially or fully reverse payments or issue refunds. In some embodiments, any of the processes described with reference to the provider computing system 110 or the processing circuit 111 can be performed by the third-party computing system 140.

The system 100 can include a network 155. The network 155 can be a communication infrastructure including physical or wireless transmission media, routing equipment, switching equipment, and protocol stacks that enable data exchange between the provider computing system 110, the user device 120, the professional device 130, and the third-party computing system 140. For example, the network 155 can include routers, switches, network interface cards, wireless access points, cellular base stations, optical fiber links, coaxial cables, Ethernet cables, or radio frequency transceivers, among others, that facilitate transmission of data packets between computing devices. The network 155 may implement one or more communication protocols such as Transmission Control Protocol/Internet Protocol (TCP/IP), Hypertext Transfer Protocol (HTTP), Hypertext Transfer Protocol Secure (HTTPS), WebSocket, User Datagram Protocol (UDP), or other network protocols to encapsulate and route data between source and destination devices. In some implementations, the network 155 can include the Internet, one or more local area networks (LANs), one or more wide area networks (WANs), one or more cellular networks, one or more metropolitan area networks (MANs), or combinations thereof. In some implementations, the network 155 can operate using packet-switched routing to deliver data packets from a source device to a destination device by routing the packets through intermediate network nodes based on destination addresses embedded in packet headers. For example, the network 155 can transmit user input data from the user device 120 to the provider computing system 110, transmit display data from the provider computing system 110 to the user device 120, transmit matching information from the provider computing system 110 to the professional device 130, and transmit professional responses from the professional device 130 to the provider computing system 110.

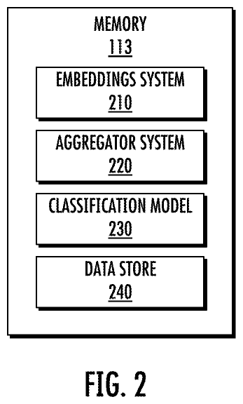

Referring now to FIG. 2, a block diagram of the memory 113 of FIG. 1 is shown in greater detail, according to an example embodiment. The memory 113 can include an embeddings system 210, an aggregator system 220, a classification model 230, and a data store 240.

The memory 113 can include an embeddings system 210. The embeddings system 210 can be a software component or set of processor-executable instructions that implement a multimodal embeddings model configured to generate numerical vector representations of two input types (e.g., text and media inputs) in a shared contextual embedding space. The embeddings system 210 can generate respective vector embeddings representing user input data including text inputs and media inputs received from user devices. In some implementations, the embeddings system 210 can generate one or more separate embeddings for the text input and for the media input in a shared contextual embedding space (e.g., one text embedding for one inputted text string and two image embeddings for two inputted medias, such as two or more images), such that the generated embeddings can be combined or aggregated into a single representation for classification. For example, the embeddings system 210 may receive user input data containing a text string “I need to fix these bare patches” and an image depicting lawn damage with discolored grass areas, process the text string to compute a 512-dimensional text embedding vector, and process the image to compute a 512-dimensional image embedding vector, such that both vectors reside in the same embedding space and can be aggregated by the aggregator system 220. It will be appreciated that any size of dimensional vectors may be used, such as a 256-dimensional embedding vector, a 512-dimensional embedding vector, a 768-dimensional embedding vector, a 1024-dimensional embedding vector, etc. In some embodiments, the embedding vector for one input could have a first size (e.g., a 256-dimensional embedding vector) and the embedding vector for another input could have a second size (e.g., 512-dimensional embedding vector). It will be appreciated that any combination of embedding vector sizes may be used.

The embeddings system 210 can include an OpenCLIP transformer model or similar pre-trained model that has been trained to jointly represent text and images by predicting image captions, such that the embeddings system 210 can produce embeddings that capture semantic relationships between text and images. However, it will be appreciated that other pre-trained models may be used, such as OpenCLIP VIT-g-14, or a lighter model such as VIT-L-14. The embeddings system 210 may execute operations by loading pre-trained model weights from the data store 240, processing input data through transformer layers to generate vector embeddings, and outputting the embeddings to the aggregator system 220 for aggregation operations. The operations may include forward passes through neural network layers including attention mechanisms, feedforward layers, and normalization operations to transform input text and images into fixed-dimensional vector representations that encode semantic content of the inputs.

The memory 113 can include an aggregator system 220. The aggregator system 220 can be a software component or set of processor-executable instructions that implement aggregation algorithms configured to combine variable-length sets of embeddings into fixed-dimensional vector representations. The aggregator system 220 can aggregate the generated vector embeddings received from the embeddings system 210 into a combined vector representation that can be input to the classification model 230. In some implementations, the aggregator system 220 can implement pooling operations that average multiple image embeddings when multiple images are provided. For example, when the user input includes three images and one text input, the aggregator system 220 may compute three separate image embedding vectors from the embeddings system 210, sum the three image embedding vectors element-wise, divide each element of the summed vector by three to produce an averaged image representation, and combine the averaged image representation with a text embedding vector received from the embeddings system 210 by summing corresponding elements of the averaged image representation and the text embedding vector to produce the combined vector representation. The aggregator system 220 may apply a weighting scheme to weight the image embeddings different than the text embeddings during aggregation. For example, the aggregator system 220 may multiply each element of the averaged image representation by a first weight value and may multiply each element of the text embedding vector by a second weight value prior to summing the weighted vectors, such that the relative contributions of image and text inputs can be tuned to optimize classification performance. For example, one of the weights can be adjusted based feedback received from the user (e.g., adjust a weight when user indicates the predicted category is not accurate), or by the system administrator. The aggregator system 220 may execute aggregation operations by receiving embeddings from the embeddings system 210, computing averages of image embeddings or audio embeddings when multiple images or audio inputs are present by summing image embedding vectors or audio embedding vectors and dividing by a count of images, and combining the averaged image representation with the text representation according to predefined aggregation rules to produce the combined vector representation. The operations may include summing or scaling the image representation and text representation, dividing by the number of images to compute an average image representation, and outputting the combined vector to the classification model 230 for probability distribution generation.

The memory 113 can include a classification model 230. The classification model 230 can be a trained multiclass classification model including learned model parameters configured to generate probability distributions over a predefined plurality of categories based on aggregated vector representations received from the aggregator system 220. For example, the classification model 230 may include a logistic regression model that computes a softmax function over category outputs by calculating exponentials of weighted sums of input features and normalizing the exponentials to produce probabilities that sum to one across the categories. In some implementations, the classification model 230 can include alternative model families such as gradient boosting models, random forest models, or fine-tuned transformer models trained using labeled training data stored in the data store 240. For example, a gradient boosting model may iteratively build an ensemble of decision trees by fitting each successive tree to residual errors from prior trees, apply the ensemble to the aggregated vector representation to generate a score for each category, and normalize the scores using a softmax operation to produce the probability distribution over the predefined plurality of categories. The classification model 230 can apply the trained multiclass classification model to the aggregated vector representation to generate a probability distribution over the predefined plurality of categories. In some implementations, the classification model 230 can include a plurality of trained multiclass classification models that are chained in a hierarchical fashion to generate the probability distribution, such that a first classification model may predict a broader category from a first subset of the predefined plurality of categories and a second classification model may predict a narrower category from a second subset of categories within the broader category predicted by the first classification model. For example, if the predefined plurality of categories includes 95 service categories organized into 10 high-level category groups, the classification model 230 may apply a first logistic regression model to the aggregated vector representation to predict one of the 10 high-level category groups, and may apply a second logistic regression model specific to the predicted high-level category group to predict one of the narrower service categories within that group, such that the hierarchical chaining can reduce classification complexity and improve prediction accuracy for large category taxonomies. The classification model 230 may execute inference operations by loading trained model coefficients from the data store 240, performing matrix multiplications between the aggregated vector representation and the model coefficients to compute weighted sums of input features for each category, and applying softmax operations to the weighted sums to compute normalized probability distributions over the categories. The classification model 230 may output the probability distribution to the processor 112 for category selection and user interface generation.

The memory 113 can include a data store 240. The data store 240 can be a storage component or database configured to store model parameters, training data, category definitions, thresholds, and other data required for multimodal search functionality. For example, the data store 240 can store pre-trained embeddings model weights for transformer models, trained logistic regression coefficients for the classification model 230, labeled training data generated by associating historical user inputs with categories corresponding to professionals contacted by users, and predefined taxonomies of service categories. The data store 240 can provide model parameters and training data to the embeddings system 210, the aggregator system 220, and the classification model 230 to enable embeddings generation, aggregation operations, and classification model outputs. In some implementations, the data store 240 can store labeled training data constructed from historical user interactions, such that the classification model 230 can be trained or updated using the labeled data to learn patterns specific to the service platform. For example, the labeled training data may associate a user input including a text description “I need to fix these bare patches” and an image showing discolored lawn areas with a category identifier corresponding to “Lawn Care Services” based on the category of the professional contacted by the user who provided that input, such that the classification model 230 can learn to predict the “Lawn Care Services” category for similar future inputs. The data store 240 may organize stored data in data structures such as relational databases, or file systems that can be accessed by the processor 112 to load model weights, retrieve training data, or obtain category definitions. For example, the data store 240 may maintain a category taxonomy in which a broader category “Home Services” includes narrower categories “Lawn Care Services,” “Appliance Installation,” and “Handyman Services,” and may store hierarchical relationships indicating that a professional offering “Lawn Care Services” may also offer services in related categories such as “Landscaping” or “Tree Trimming,” such that the classification model 230 can invoke hierarchical classification models that first predict the broader category and then predict the narrower category within the predicted broader category.

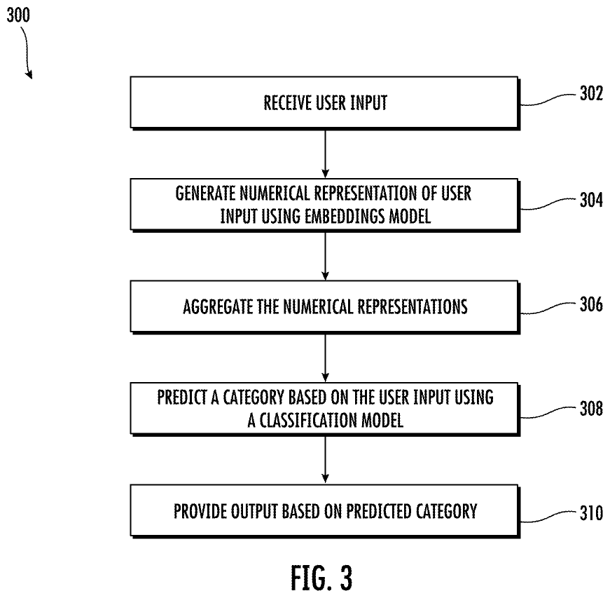

Referring now to FIG. 3, a flowchart illustrating an embeddings-based category prediction method 300 for generating an output responsive to a user-provided input is shown, according to an example embodiment. The method 300 can be executed, performed, or otherwise carried out by any of the computing systems or devices described herein, such as the provider computing system 110, the processing circuit 111, or the third-party computing system 140.

The method 300 can include receiving a user input (step 302). The user input can be received by the user device 120 which then transmits user input data to the provider computing system 110. The user input can include a text input and a media input. In some implementations, the user input can include any number of text inputs and media inputs, such as image inputs, video inputs, or audio inputs. For example, the user input data may be based on natural language text describing a service need, one or more images showing aspects of the service need such as photographs of a problem area or project site, video footage depicting the service need in motion or over time, or audio recordings containing spoken descriptions of the service requirement or sounds indicating a service need (e.g., sounds from a home appliance, a buzzing electrical appliance, etc.). In this way, the user can describe service needs using multiple input modalities. The provider computing system 110 can receive the user input data via the network 155 by parsing incoming data from the user device 120, extracting text inputs and media inputs from the incoming data, and preparing the incoming data for processing by the embeddings system 210. For example, preparing the incoming data for processing by the embeddings system 210 can include resizing images to conform to input requirements of the embeddings system 210, converting video inputs into sequences of frames or extracting key frames for analysis, transcribing audio inputs into text representations using speech recognition, converting formats of images, videos, or audio files into standardized formats, and organizing the inputs into data structures suitable for batch processing by the embeddings system 210.

The method 300 can include generating numerical representations of user inputs using an embeddings model (step 304). The numerical representation can be generated by the embeddings system 210 of the provider computing system 110. The embeddings system 210 can generate, by a multimodal embeddings model, respective vector embeddings representing the user input data. For example, the embeddings system 210 may receive user input data containing a text string describing a service need and one or more images illustrating the service need, process the text string by tokenizing the text into sub-word units and passing the tokens through a text encoder to produce a text embedding vector, and process each image by dividing the image into sub-image units and passing the sub-image units through an image encoder to produce an image embedding vector for each image. The embeddings system 210 can store all of the embeddings in a shared contextual embedding space where semantically similar text and images are represented by vectors. In some implementations, the numerical representation is produced based on pre-trained model weights from the data store 240. In some implementations, the embeddings system 210 can identify relationships between different parts of the text input and between different regions of each media input to understand how different portions of the inputs relate to each other, and generate numerical vectors that capture the meaning of the inputs. The embeddings system 210 then outputs the embeddings to the aggregator system 220.

The method 300 can include aggregating the numerical representations (step 306). The numerical representations can be aggregated by the aggregator system 220 of the provider computing system 110. The aggregator system 220 can aggregate the generated vector embeddings into a combined vector representation. For example, the aggregator system 220 may combine multiple image embeddings when multiple images are present by averaging the image embedding vectors to produce an averaged image representation, and then may combine the averaged image representation with the text representation to produce the combined vector representation. The numerical representations can be aggregated in response to the embeddings system 210 generating the vector embeddings in step 304, such that the embeddings can be combined into a single representation suitable for input to the classification model 230. In some implementations, the numerical representations can be aggregated after all embeddings for the text input and media inputs have been generated, such that the aggregator system 220 can process a complete set of embeddings for the user input. The aggregator system 220 can aggregate the numerical representations by receiving the embeddings from the embeddings system 210, computing averages of image embeddings when multiple images are present, combining the averaged image embeddings with the text embeddings according to predefined aggregation rules, and outputting the combined vector representation to the classification model 230. In some implementations, the aggregation operations may include applying weights to weight image embeddings differently than text embeddings, combining the image and text representations to produce the combined vector, and formatting the combined vector to meet input requirements of the classification model 230.

The method 300 can include predicting a category based on the user input using a classification model (step 308). The category can be predicted by the classification model 230 of the provider computing system 110. The classification model 230 can apply a trained multiclass classification model to the aggregated vector representation to generate a probability distribution over a predefined plurality of categories, and can select a predicted category from the plurality of categories based on the probability distribution. In some implementations, the classification model 230 can compute a softmax function over outputs of a logistic regression model to generate normalized probabilities for each category in the predefined plurality of categories. For example, the classification model 230 can estimate a logistic regression model according to the following formula:

$$Pr ( {Y}_{i} = c \vert {X}_{i} ; β ) = \frac{exp {β}_{c} {X}_{i}}{{\sum }_{j ∈ C} exp {β}_{j} {X}_{i}} \qquad ( eqn . 1 )$$

where Xᵢ is the embeddings aggregated vector of observation i, c is the ground truth category, and β is the vector of coefficients to be estimated. The most likely category can then be determined according to the following formula:

$$arg \frac{max}{j ∈ C} Pr ( {Y}_{i} = j \vert {X}_{i} ; β ) \qquad ( eqn . 2 )$$

In other words, the classification model 230 may calculate exponentials of weighted sums of input features for each category, sum the exponentials across all categories to obtain a normalization constant, and divide each exponential by the normalization constant to produce probabilities that sum to one across the predefined plurality of categories. The classification model 230 may select the category with the highest probability as the predicted category by performing an argmax operation over the probability distribution.

In some implementations, the category can be predicted immediately in response to the aggregator system 220 producing the combined vector representation, or predicted after the aggregated vector representation has been validated to conform to input requirements of the classification model 230 (e.g., such as verifying that the dimensional of the aggregated vector matches an input dimension of the of the classification model 230. The classification model 230 can predict the category by loading trained model coefficients from the data store 240, performing matrix multiplications between the aggregated vector representation and the model coefficients to compute weighted sums for each category, applying softmax operations to compute normalized probability distributions over the categories, and selecting the category having the highest probability in the probability distribution. The classification model 230 may use hierarchical classification models when the predicted category falls within a predefined subset of categories, such that a first classification model may predict a broader category from a first subset of the predefined plurality of categories and a second classification model may predict a narrower category from a second subset of categories within the broader category predicted by the first classification model.

In some implementations, the prediction operations may include determining a confidence score based on the probability distribution by extracting the maximum probability value or computing a margin between the highest probability and the second-highest probability. For example, the classification model 230 may extract the maximum probability value from the probability distribution and compare the value to a predefined threshold to determine whether to present the predicted category or to request additional user input via the user device 120.

The method 300 can include providing an output based on the predicted category (step 310). The output can be provided by the provider computing system 110 to the user device 120. The provider computing system 110 can provide, to the user device 120, display data based on the selected predicted category, the display data configured to cause the user device 120 to display a user interface based on the selected predicted category. The display data may contain the predicted category and associated metadata that enables the user device 120 to render contextual information for the user's review, confirmation, or refinement of the category prediction. In some implementations, the display data can include alternative category suggestions ranked by likelihood when the probability distribution indicates multiple possible categories, or can include prompts requesting additional user input when the confidence score from the probability distribution is below a predefined threshold. In some implementations, the transmission operations may include transmitting matching information to professional devices 130 when the user confirms the predicted category, such that service professionals offering services in the confirmed category can be notified of the user service request.

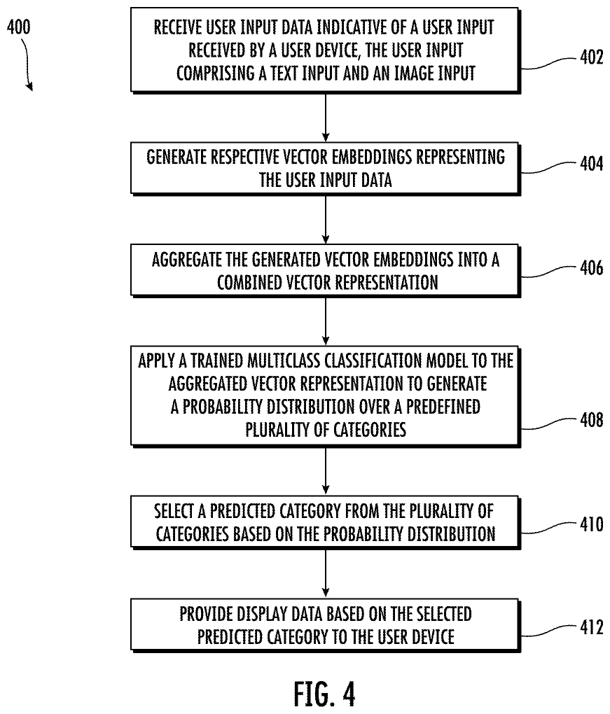

Referring now to FIG. 4, a flow diagram illustrating another embeddings-based category prediction method 400 for generating an output responsive to a user-provided input is shown, according to an example embodiment. The method 400 can be executed, performed, or otherwise carried out by any of the computing systems or devices described herein, such as the provider computing system 110, the processing circuit 111, or the third-party computing system 140.

The method 400 can include receiving user input data indicative of a user input received by a user device, the user input including a text input and an image input (step 402). The user input data can be received by the provider computing system 110 in a manner similar to the operations described with reference to step 302 of FIG. 3. The user input can include natural language text describing a service need and one or more images illustrating aspects of the service need. The text input can be entered by the user via a text input field and the image input can be captured by the user via a camera interface or selected from stored images on the user device.

The method 400 can include generating respective vector embeddings representing the user input data (step 404). The respective vector embeddings can be generated by the embeddings system 210 of the provider computing system 110 in a manner similar to the operations described with reference to step 304 of FIG. 3. The embeddings system 210 can generate, by a multimodal embeddings model, respective vector embeddings representing the user input data. For example, the embeddings system 210 may process the text input through transformer encoder layers to produce a text embedding vector and may process each image input through vision transformer layers or convolutional layers to produce image embedding vectors, such that the embeddings reside in a shared contextual embedding space that captures semantic relationships between text and images.

The method 400 can include aggregating the generated vector embeddings into a combined vector representation (step 406). The generated vector embeddings can be aggregated by the aggregator system 220 of the provider computing system 110 in a manner similar to the operations described with reference to step 306 of FIG. 3. The aggregator system 220 can aggregate the generated vector embeddings into a combined vector representation. For example, when the user input includes multiple images, the aggregator system 220 may compute an average of the image embedding vectors by summing the vectors and dividing each summed vector by the number of images to produce an averaged image representation, and may combine the averaged image representation with the text embedding vector by summing the average image representation and the text embedding vector. In some implementations, the aggregator system 220 can apply a weighting scheme to weight image embeddings differently than text embeddings by multiplying elements of the averaged image representation by a first weight value and elements of the text embedding vector by a second weight value prior to summing the weighted vectors.

The method 400 can include applying a trained multiclass classification model to the aggregated vector representation to generate a probability distribution over a predefined plurality of categories (step 408). The trained multiclass classification model can be applied by the classification model 230 of the provider computing system 110 in a manner similar to the operations described with reference to step 308 of FIG. 3. The classification model 230 can apply a trained multiclass classification model to the aggregated vector representation to generate a probability distribution over the predefined plurality of categories. In some implementations, the classification model 230 can use hierarchical classification models when the predicted category falls within a predefined subset of categories, such that a first classification model may predict a broader category from a first subset of the predefined plurality of categories and a second classification model may predict a narrower category from a second subset of categories within the broader category predicted by the first classification model. The classification model 230 may generate calibrated probability scores that can be used as confidence signals for downstream decision-making, such that the predicted probabilities can be used to determine whether to present the predicted category to the user or to prompt the user for additional information.

The method 400 can include selecting a predicted category from the plurality of categories based on the probability distribution (step 410). The predicted category can be selected by the classification model 230 of the provider computing system 110. The classification model 230 can select the predicted category from the plurality of categories based on the probability distribution generated in step 408. For example, the classification model 230 may identify the category having the highest probability value in the probability distribution and may designate that category as the predicted category, such that the selected category represents the most likely service category corresponding to the user input data received in step 402.

In some implementations, the classification model 230 can determine a confidence score based on the probability distribution prior to finalizing the category selection, such that the system can evaluate whether the confidence score exceeds a predefined threshold before presenting the predicted category to the user or prompting the user for additional information. For example, the classification model 230 may compute the confidence score by extracting the maximum probability value from the probability distribution, determining a margin between the highest probability value and the second-highest probability value, or applying a calibration function to the maximum probability value. In some implementations, the classification model 230 can generate a ranked list of alternative predicted categories by sorting the categories based on their respective probability values and selecting a predetermined number of highest-ranked categories, such that the display data can present multiple category options to the user when the confidence score indicates uncertainty or when the user requests alternative suggestions. The display data can include the alternative predicted categories and their category names, category descriptions, and indications based on their confidence scores.

The method 400 can include providing display data based on the selected predicted category to the user device (step 412). The display data can be provided by the provider computing system 110 to the user device 120 in a manner similar to the operations described with reference to step 310 of FIG. 3. The provider computing system 110 can provide, to the user device 120, display data based on the selected predicted category, the display data configured to cause the user device 120 to display a user interface based on the selected predicted category. The display data may contain the predicted category and associated metadata that enables the user device 120 to render contextual information for user review, confirmation, or refinement of the category prediction. In some implementations, the display data can include alternative category suggestions ranked by likelihood when the probability distribution indicates multiple possible categories, or can include prompts requesting additional user input when a confidence score from the probability distribution is below a predefined threshold. In some implementations, the transmission operations may include transmitting matching information to professional devices 130 when the user confirms the predicted category, such that service professionals offering services in the confirmed category can be notified of the user service request.

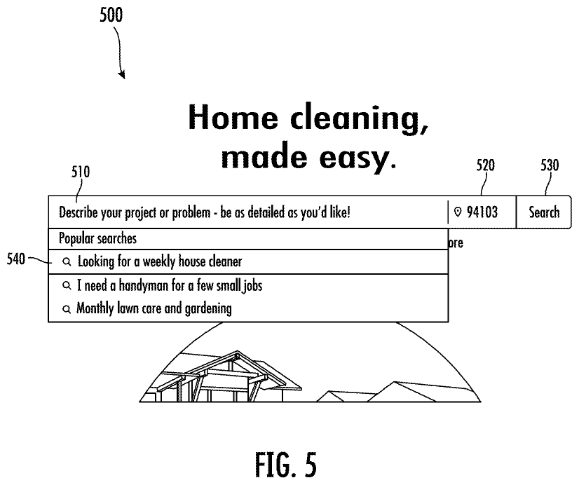

Referring now to FIG. 5, an illustration of a user interface 500 for entering a service request query and initiating a search within the multimodal search system is shown, according to an example embodiment. The user interface 500 can be displayed on the user device 120 and can include a query input field 510, a location input field 520, a search button 530, and a suggested queries list 540. The user interface 500 can be used by the user to input service needs using text descriptions using the query input field 510, location information using the location input field 520, or selections from pre-populated query suggestions using the suggested queries list 540. The search button 530 can be selected by the user to cause the inputted or selected information to be transmitted to the provider computing system 110 as the user input data. The location input field 520 can receive a location identifier (e.g., a ZIP code) that may be used by the provider computing system 110 to match the user's service needs with a service professional that services the geographic area indicated by the location data. The suggested queries list 540 can be a display element presenting one or more pre-populated query suggestions that the user can select to populate the query input field 510 with a suggested query text. The user interface 500 may be rendered by the processor 126 of the user device 120 based on display data received from the provider computing system 110 via the network interface 128. In some implementations, the user interface 500 may be displayed on a user device 110 that is a personal computer or tablet computer.

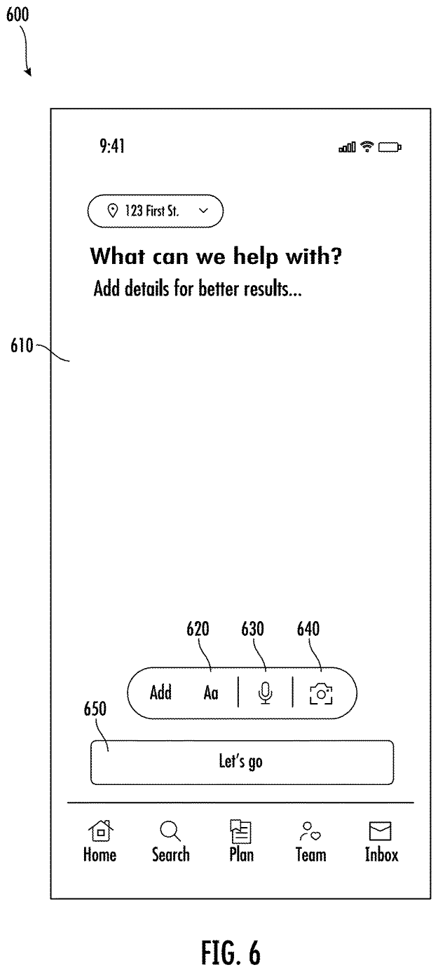

Referring now to FIG. 6, an illustration of a user interface 600 of a multimodal search input screen for submitting a query using multiple input modalities is shown, according to an example embodiment. The user interface 600 can be displayed on the user device 120 and can include a search input interface region 610, a text input button 620, an audio input button 630, an image capture button 640, and a search button 650. The user interface 600 may be rendered by the processor 126 of the user device 120 based on display data received from the provider computing system 110 via the network interface 128. In some implementations, the user interface 600 may be displayed on a user device 110 that is a mobile device such as a smartphone.

The search input interface region 610 can be a display area presenting heading text and instructional prompts that guide the user to provide multimodal inputs for searching for a service professional. The search input interface region 610 can include a heading such as “What can we help with?” and subtext such as “Add details for better results . . . ” that prompt the user to provide detailed descriptions of service needs using multiple input modalities. In some implementations, the search input interface region 610 can display location information such as an address or geographic identifier to indicate the service area where professionals will be sourced.

The text input button 620 can be an interactive control element configured to activate a text input interface when selected by the user, such that the user can enter natural language text describing a service need. The audio input button 630 can be an interactive control element configured to activate an audio capture interface when selected by the user, such that the user can provide spoken descriptions of service needs, or record sounds indicating a service need (e.g., sounds from a home appliance, a buzzing electrical appliance, etc.). The image capture button 640 can be an interactive control element configured to activate an image capture or selection interface when selected by the user, such that the user can provide one or more images or videos depicting service needs (e.g., upload one or more images showing damaged lawn areas, a dripping faucet, etc.).

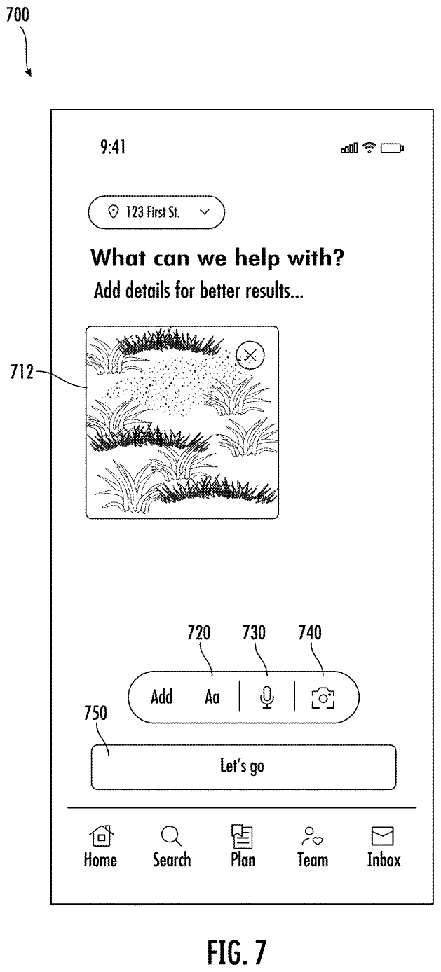

Referring now to FIG. 7, an illustration of a user interface 700 of a multimodal search interface showing receipt of an image input is shown, according to an example embodiment. The user interface 700 can include an uploaded image preview 712, a text input button 720, an audio input button 730, an image capture button 740, and a search button 750. The text input button 720, the audio input button 730, the image capture button 740, and the search button 750 can be similar to and have similar functionality as the text input button 620, the audio input button 630, the image capture button 640, and the search button 750, respectively, described above with reference to FIG. 6. The user interface 700 may be rendered by the processor 126 of the user device 120 based on display data received from the provider computing system 110 via the network interface 128. In some implementations, the user interface 700 may be displayed on a user device 110 that is a mobile device such as a smartphone.

The user interface 700 is displayed following the user inputting an image via the image capture button 640 of the user interface 600 shown in FIG. 6. The user interface 700 can include the uploaded image preview 712, which can present a visual representation of the uploaded image. The user interface 700 can display the text input button 720, the audio input button 730, the image capture button 740, and the search button 750 to enable the user to supplement the uploaded image with additional inputs prior to initiating the search query using the search button 750. In some implementations, the uploaded image preview 712 can include an interactive control such as a close button or delete button that the user can select to remove the uploaded image. For example, the user may select the delete button to discard the uploaded image preview 712 and select the image capture button 740 to capture a different image using a camera of the user device 120 or to select a different image from images stored on the user device 120.

The uploaded image preview 712 can be rendered by the processor 126 of the user device 120 by loading image data from a temporary storage location, decoding the image data into a displayable format, resizing the image to fit the preview area, and rendering the image within the user interface 700. The rendering operations may include applying image processing operations such as scaling, cropping, or thumbnail generation to optimize the display of the image preview.

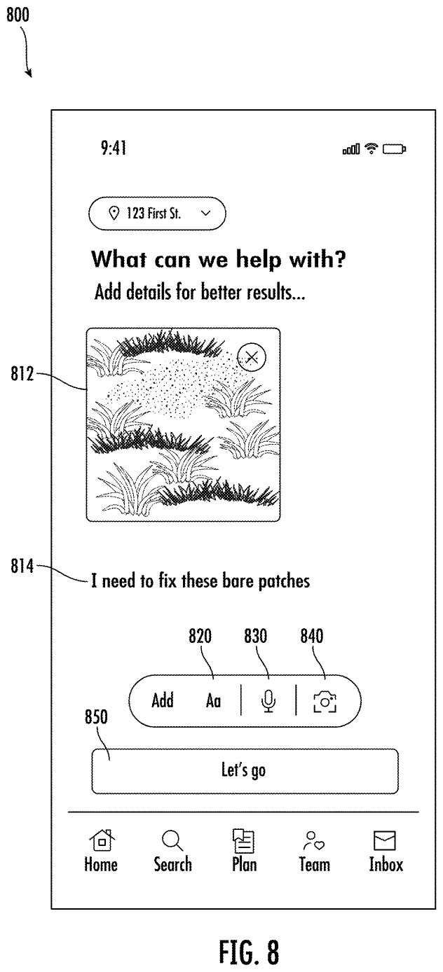

Referring now to FIG. 8, an illustration of a user interface 800 of a multimodal search input screen showing receipt of an image input and input text is shown, according to an example embodiment. The user interface 800 can include an uploaded image preview 812, a text description input 814, a text input button 820, an audio input button 830, an image input button 840, and a search button 850. The uploaded image preview 812, text input button 820, the audio input button 830, the image capture button 840, and the search button 850 can be similar to and have similar functionality as the uploaded image preview 712, text input button 720, the audio input button 730, the image capture button 740, and the search button 750, respectively, described above with reference to FIG. 7. The user interface 800 may be rendered by the processor 126 of the user device 120 based on display data received from the provider computing system 110 via the network interface 128. In some implementations, the user interface 800 may be displayed on a user device 110 that is a mobile device such as a smartphone.

The user interface 800 is displayed following the user inputting a text description via the text input button 820. The user interface 800 can include the uploaded image preview 812, which can present a visual representation of the uploaded image in a manner similar to the uploaded image preview 712 of FIG. 7, and the text description input 814 displaying natural language text entered by the user to describe a service need or project requirement. For example, the user interface 800 can include a screen layout displaying a preview of a captured or selected image showing lawn damage alongside a text field containing a natural language description such as “I need to fix these bare patches,” which together make up a multimodal user input data to be transmitted to the provider computing system 110 for category prediction. In some implementations, the text description input 814 can display text that has been entered by the user via a text input field activated by the text input button 820, or can display text that has been transcribed from audio input captured via the audio input button 830.

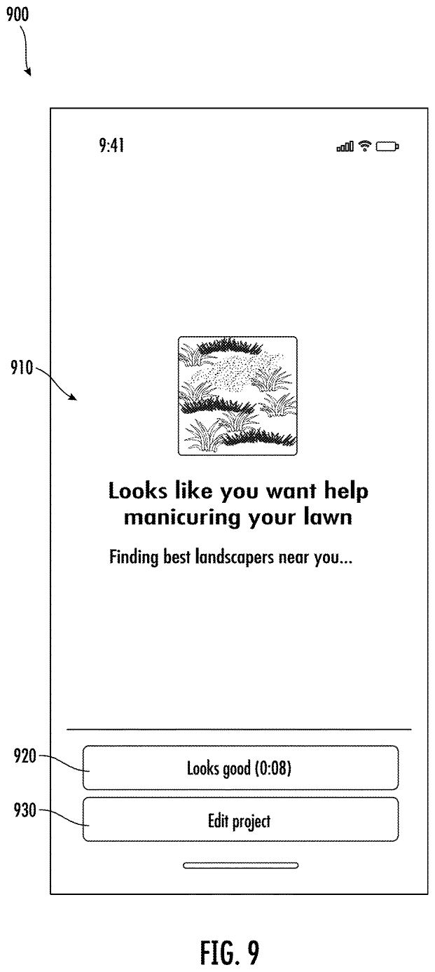

Referring now to FIG. 9, an illustration of a user interface 900 of a multimodal search output screen presenting a predicted category is shown, according to an example embodiment. The user interface 900 can include a predicted category display region 910, a confirm selection button 920, and an edit project button 930. The user interface 900 may be rendered by the processor 126 of the user device 120 based on display data received from the provider computing system 110 via the network interface 128. In some implementations, the user interface 900 may be displayed on a user device 110 that is a mobile device such as a smartphone.

The user interface 900 is displayed following the user inputting one or more inputs (e.g., natural language text and an image) and selecting the search button (e.g., search button 750, search button 850). The user interface 900 presents the results of category prediction operations performed by the provider computing system 110 in response to the user input. For example, the user interface 900 can show the predicted category selected by the classification model 230 based on a provided multimodal input, such as an image of lawn damage and text describing the need to fix bare patches, resulting in a prediction of “manicuring your lawn” as the service category. The user interface 900 can display the predicted category along with the confirm selection button 920 and the edit project button 930 that enable the user to verify the accuracy of the predicted category before proceeding to match with service professionals.

The predicted category display region 910 can be a display area showing the predicted category generated by the classification model 230 based on the multimodal user input, along with contextual information and visual elements supporting the prediction. For example, the predicted category display region 910 can include a preview of the input image showing lawn damage, text stating “Looks like you want help manicuring your lawn,” and status text indicating “Finding best landscapers near you . . . ” to communicate the predicted category and the subsequent matching operation to the user.

The confirm selection button 920 can be an interactive control element that transmits a confirmation signal to the provider computing system 110 when selected by the user, such that the provider computing system 110 can proceed with matching the user with service professionals in the predicted category. For example, the confirm selection button 920 can include a button labeled “Looks good (0:08)” indicating that the predicted category appears correct to the user and displaying a countdown timer showing the time remaining before automatic confirmation, thereby enabling the user to expedite the matching process by selecting the confirm selection button 920 prior to the timer running down.

The edit project button 930 can be an interactive control element that changes the user interface to an editing mode when activated by the user, such that the user can modify the user input or provide additional information to refine the category prediction. For example, when selected, the edit project button 930 can return the user to a user interface enabling the user to modify the text description, add or remove images, provide additional details to improve the accuracy of the category prediction, or start the search over (e.g., by displaying user interfaces 500, 600, 700, or 800). In some implementations, the edit project button 930 can be displayed when the confidence score determined based on the probability distribution generated by the classification model 230 falls below a predefined threshold, such that the system can prompt the user to provide additional information to improve prediction accuracy rather than proceeding with an uncertain category prediction.

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As utilized herein, terms of degree such as “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to any precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that terms such as “exemplary,” “example,” and similar terms, as used herein to describe various embodiments, are intended to indicate that such embodiments are possible examples, representations, or illustrations of possible embodiments, and such terms are not intended to connote that such embodiments are necessarily extraordinary or superlative examples.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any element on its own or any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the drawings. It should be noted that the orientation of various elements may differ according to other exemplary embodiments, and that such variations are intended to be encompassed by the present disclosure.

As used herein, terms such as “engine,” “circuit,” and “system” may include hardware and machine-readable media storing instructions thereon for configuring the hardware to execute the functions described herein. The engine, circuit, or system may be embodied as one or more circuitry components including, but not limited to, processing circuitry, network interfaces, peripheral devices, input devices, output devices, sensors, etc. In some embodiments, the engine, circuit, or system may take the form of one or more analog circuits, electronic circuits (e.g., integrated circuits (IC), discrete circuits, system on a chip (SOCs) circuits, etc.), telecommunication circuits, hybrid circuits, and any other type of circuit. In this regard, the engine, circuit, or system may include any type of component for accomplishing or facilitating achievement of the operations described herein. For example, an engine, circuit, or system as described herein may include one or more transistors, logic gates (e.g., NAND, AND, NOR, OR, XOR, NOT, XNOR, etc.), resistors, multiplexers, registers, capacitors, inductors, diodes, wiring, and so on).

An engine, circuit, or system may be embodied as one or more processing circuits comprising one or more processors communicatively coupled to one or more memory or memory devices. In this regard, the one or more processors may execute instructions stored in the memory or may execute instructions otherwise accessible to the one or more processors. The one or more processors may be constructed in a manner sufficient to perform at least the operations described herein. In some embodiments, the one or more processors may be shared by multiple engines, circuits, or systems (e.g., engine A and engine B, circuit A and circuit B, or system A or system B may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more suitable processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal or local to the apparatus. In this regard, a given engine, circuit, or system or components thereof may be disposed locally (e.g., as part of a local server, a local computing system, etc.) or remotely (e.g., as part of a remote server such as a cloud based server). To that end, engines, circuits, or systems as described herein may include components that are distributed across one or more locations.

An example system for providing the overall system or portions of the embodiments described herein might include one or more computers, including a processing unit, a system memory, and a system bus that couples various system components including the system memory to the processing unit. Each memory device may include non-transient volatile storage media, non-volatile storage media, non-transitory storage media (e.g., one or more volatile or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

Although the drawings may show and the description may describe a specific order and composition of method steps, the order of such steps may differ from what is depicted and described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions, and arrangement of the embodiments without departing from the scope of the present disclosure as expressed in the appended claims.

What is claimed is:

1. A method comprising:
receiving, by a processing circuit of a provider computing system and from a user device, user input data indicative of a user input received by the user device, the user input comprising a text input and a media input;
generating, by a multimodal embeddings model, respective vector embeddings representing the user input data;
aggregating the generated vector embeddings into a combined vector representation;
applying a trained multiclass classification model to the aggregated vector representation to generate a probability distribution over a predefined plurality of categories;
selecting a predicted category from the plurality of categories based on the probability distribution; and
providing, by the processing circuit and to the user device, display data based on the selected predicted category, the display data configured to cause the user device to display a user interface based on the selected predicted category.

2. The method of claim 1, wherein generating respective vector embeddings comprises generating embeddings for the text input and for the media input in a shared contextual embedding space.

3. The method of claim 1, wherein the media input comprises a plurality of images, and aggregating the generated vector embeddings comprises combining the image embeddings and combining the combined image embeddings with the text embeddings to produce the combined vector representation.

4. The method of claim 1, wherein the trained multiclass classification model comprises a plurality of trained multiclass classification models.

5. The method of claim 4, wherein the plurality of trained multiclass classification models are chained in a hierarchical fashion to generate the probability distribution.

6. The method of claim 1, further comprising determining a confidence score based on the probability distribution and prompting the user device to request additional user input based on the confidence score being below a threshold.

7. The method of claim 1, wherein selecting the predicted category from the plurality of categories based on the probability distribution comprises selecting the category having the highest probability in the probability distribution.

8. The method of claim 1, further comprises applying a weighting scheme to weight the image embeddings different than the text embeddings during aggregation.

9. The method of claim 1, wherein the trained multiclass classification model comprises a logistic regression model configured to generate the probability distribution.

10. The method of claim 1, wherein the multimodal embeddings model is trained to jointly represent text and images by predicting image captions.

11. The method of claim 1, wherein the multimodal embeddings model comprises an OpenCLIP transformer model.

12. The method of claim 1, further comprising training the multiclass classification model using labeled training data generated by associating historical user inputs with categories corresponding to professionals contacted by users.

13. The method of claim 1, further comprising deploying the trained multiclass classification model on a GPU-based computing infrastructure configured to minimize latency of category prediction.

14. The method of claim 1, further comprising monitoring an accuracy of the selected predicted category based on comparing the selected predicted category to a final category based on at least one of a category offered by a service professional selected by the user or based on a second user input providing at least one of an additional text input or an additional media input.

15. The method of claim 1, further comprising matching a user associated with the user device with a service professional based on the selected predicted category corresponding to a service offered by the service professional.

16. A system comprising:
one or more processors coupled to one or more non-transitory computer-readable storage mediums comprising program instructions that, when executed by the one or more processors, cause the one or more processors to perform operations comprising:
receiving, from a user device, user input data indicative of a user input received by the user device, the user input comprising a text input and a media input;
generating, by a multimodal embeddings model, respective vector embeddings representing the user input data;
aggregating the generated vector embeddings into a combined vector representation;
applying a trained multiclass classification model to the aggregated vector representation to generate a probability distribution over a predefined plurality of categories;
selecting a predicted category from the plurality of categories based on the probability distribution; and
providing, to the user device, display data based on the selected predicted category, the display data configured to cause the user device to display a user interface based on the selected predicted category.

17. The system of claim 16, wherein the user input is a first user input, and the user interface displayed on the user device is configured to receive a second user input for the user to confirm or refine the predicted category.

18. The system of claim 16, wherein the user input data is received via a user interface configured to simultaneously accept natural language text and at least one of image inputs, video inputs, or audio inputs.

19. The system of claim 16, wherein the display data causes the user device to present a list of alternative predicted categories ranked by likelihood based on the probability distribution.

20. A non-transitory computer storage medium encoded with a computer program, the computer program comprising a plurality of program instructions that when executed by one or more processors cause the one or more processors to perform operations comprising:
receiving, from a user device, user input data indicative of a user input received by the user device, the user input comprising a text input and an image input;
generating, by a multimodal embeddings model, respective vector embeddings representing the user input data;
aggregating the generated vector embeddings into a combined vector representation;
applying a trained multiclass classification model to the aggregated vector representation to generate a probability distribution over a predefined plurality of categories;
selecting a predicted category from the plurality of categories based on the probability distribution; and
matching a user associated with the user device with a service professional based on the selected predicted category corresponding to a service offered by the service professional.
